(19) United States
(12) Patent Application Publication
(10) Pub. No.: US 2019/0384495 A1
(43) Pub. Date: Dec. 19, 2019

(54) Object Store Backup Method and System

(71) Applicant: Trilio Data, Inc., Framingham, MA (US)

(72) Inventor: Murali Balcha, Holliston, MA (US)

(73) Assignee: Trilio Data, Inc., Framingham, MA (US)

(21) Appl. No.: 16/439,042

(22) Filed: Jun. 12, 2019

Related U.S. Application Data
(60) Provisional application No. 62/686,804, filed on Jun. 19, 2018.

(51) Int. Cl. G06F 3/06

(52) U.S. Cl. CPC G06F 3/065; G06F 3/0619; G06F 3/0622; G06F 3/0643; G06F 3/0673

(57) ABSTRACT

A computer-implemented method of backing up an application to an object storage system includes receiving a file comprising data from the application being backed up to the object storage system at a locally-mounted-file-system representation. A manifest comprising file segment metadata based on the file is generated. At least one file segment comprising at least some of the data is also generated. At least one file segment comprising at least some of the data as at least one corresponding object comprising the at least some of the data is stored in the object storage system. The manifest is stored as an object in the object storage system.

### CROSS REFERENCE TO RELATED APPLICATION

The present application is a non-provisional application of U.S. Provisional Patent Application No. 62/686,804, entitled “Object Store Backup Method and System” filed on Jun. 19, 2018. The entire contents of U.S. Provisional Patent Application No. 62/686,804 are herein incorporated by reference.

### INTRODUCTION

OpenStack deployments, which are free and open-source software platform for cloud computing, are growing at an astounding rate. Market research indicates that a large fraction of enterprises will be deploying some form of cloud infrastructure to support applications services, either in a public cloud, private cloud or in a hybrid of a public and private cloud. This trend leads more and more organizations to use OpenStack, open-sourced cloud management and control software, to build out and operate these clouds. Data loss is a major concern for these enterprises. Unscheduled downtime has a dramatic financial impact on businesses. As such, backup and recovery methods and systems that recover from data loss and data corruption scenarios for application workloads running on OpenStack clouds are needed.

The systems and applications being backed up may scale to very large numbers of nodes and may be widely distributed. Objectives for effective backup of these systems include reliable recovery of workloads with a significantly improved recovery time objective and recovery point objective.

### BRIEF DESCRIPTION OF THE DRAWINGS

The present teaching, in accordance with preferred and exemplary embodiments, together with further advantages thereof, is more particularly described in the following detailed description, taken in conjunction with the accompanying drawings. The skilled person in the art will understand that the drawings, described below, are for illustration purposes only. The drawings are not necessarily to scale, emphasis instead generally being placed upon illustrating principles of the teaching. The drawings are not intended to limit the scope of the Applicant's teaching in any way.

FIG. 1 illustrates an embodiment of a backup operation system and method for a cloud environment according to the present teaching.

FIG. 2 illustrates an embodiment of a virtual machine (VM) of FIG. 1 in greater detail.

FIG. 3 illustrates an embodiment of an object storage backup system of the present teaching.

FIG. 4 illustrates a schematic showing how a Linux file personality is mapped to objects in an object store using an embodiment of the system and method of the present teaching.

FIG. 5 illustrates a class diagram of an embodiment of the object store backup method and system of the present teaching.

FIG. 6A illustrates an embodiment of an object of the present teaching that comprises two file segments when the object is first created.

FIG. 6B illustrates an embodiment of an object of the present teaching that comprises two file segments when the file is opened for a read/write operation and written to.

FIG. 6C illustrates an embodiment of an object of the present teaching that comprises two file segments when the file is orderly closed.

FIG. 7 illustrates a flow chart of an embodiment of a method and system that backs up an application to an object storage system according to the present teaching.

FIG. 8 illustrates an embodiment of an object store backup system of the present teaching in the case where multiple nodes are backed up to a common object store system.

### DESCRIPTION OF VARIOUS EMBODIMENTS

Reference in the specification to “one embodiment” or “an embodiment” means that a particular feature, structure, or characteristic described in connection with the embodiment is included in at least one embodiment of the teaching. The appearances of the phrase “in one embodiment” in various places in the specification are not necessarily all referring to the same embodiment.

It should be understood that the individual steps of the methods of the present teachings may be performed in any order and/or simultaneously as long as the teaching remains operable. Furthermore, it should be understood that the apparatus and methods of the present teachings can include any number or all of the described embodiments as long as the teaching remains operable.

The present teaching will now be described in more detail with reference to exemplary embodiments thereof as shown in the accompanying drawings. While the present teachings are described in conjunction with various embodiments and examples, it is not intended that the present teachings be limited to such embodiments. On the contrary, the present teachings encompass various alternatives, modifications and equivalents, as will be appreciated by those of skill in the art. Those of ordinary skill in the art having access to the teaching herein will recognize additional implementations, modifications, and embodiments, as well as other fields of use, which are within the scope of the present disclosure as described herein.

The method and system of the present teaching provides backup operations for distributed computing environments, such as clouds, private data centers and hybrids of these environments. One feature of the method and system of the present teaching is that it provides backup operations using object storage systems as a backup target. The application and system being backed up may be a cloud computing system, such as, for example, a system that is running using an OpenStack software platform in a cloud environment. One feature of the OpenStack software platform for cloud computing is that it makes virtual servers and other virtual computing resources available as a service to customers.

OpenStack was architected as a true cloud platform with ephemeral virtual machines (VMs) as a computing platform. Information technology administrators are growing more and more comfortable running legacy applications in OpenStack environments. Some information technology organizations are even considering migrating traditional operating systems, such as a Windows-based operating system, workloads from traditional virtualization platforms to OpenStack cloud-based environments. Still, many of the information technology workloads in a typical enterprise are mixed to contain part cloud and part legacy applications.

Methods and systems of the present teaching apply to back up of applications and systems implemented in any combination of the above configurations. As will be clear to those skilled in the art, various aspects of the system and various steps of the method of the present teaching are applicable to other known computing environments, including private and public data centers and/or cloud and/or enterprise environments that run using a variety of control and management software platforms.

Backup and disaster recovery become important challenges as enterprises evolve OpenStack projects from an evaluation to production. Corporations use backup and disaster recovery solutions to recover data and applications in the event of total outage, data corruption, data loss, version control (roll-back during upgrades), and other events. Organizations typically use internal service-level agreements for recovery and corporate compliance requirements as a means to evaluate and qualify backup and recovery solutions before deploying the solution in production.

Complex business-critical information technology environments must be fully protected with fast, reliable recovery operations. One of the biggest challenges when deploying an OpenStack cloud in an organization is the ability to provide a policy-based, automated, comprehensive backup and recovery solution. The OpenStack platform offers some application programming interfaces (APIs) that can be used to cobble together a backup, however, these APIs alone are not sufficient to implement and manage a complete backup solution. In addition, each OpenStack deployment is unique, as OpenStack itself offers modularity/multiple options to implement an OpenStack cloud. Users have a choice of hypervisors, storage subsystems, network vendors, projects (i.e. Ironic) and various OpenStack distributions.

The storage system type used for the backup target is also a consideration in design and implementation of a backup solution. Particularly since the introduction of Amazon S3, object storage is quickly becoming the storage type of choice for cloud platforms. Object storage offers very reliable, highly scalable storage using cheap hardware. Object storage is used for archival, backup and disaster recovery, web hosting, documentation and a number of other use cases. However, object storage does not natively provide file semantics expected of most backup applications.

The factors described above help shape how an effective backup solution should be implemented. An ideal backup solution would act like any other OpenStack service that a tenant consumes. That is it would apply the backup policies to its workloads. Further, and just as important, the backup process must not disrupt running workloads respecting required availability and performance. In addition to full backup abilities, the backup solution must support incremental backups so that only changes are transferred, alleviating burdens on the backup storage appliances. Moreover, currently cloud workloads span multiple VMs, so this process (or service) must have the ability to back up workloads that span multiple VMs. Backup and recovery solutions must also work efficiently with object storage systems.

From a recovery perspective, more and more organizations expect shorter recovery time objectives (RTO). Cloud workloads can be large and complex and the recovery of a workload from a backup must be executed with 100% accuracy in a rapid manner. That is why it is also recommended that backups be tested to ensure successful recovery when required. Hence, a backup process must provide a means for a tenant to quickly replay a workload from backup media that can be periodically validated. Lastly, a backup service must also include a disaster recovery element. Cloud resources are highly available and periodically replicate data to multiple geographical locations. So replication of backup media to multiple locations will enhance the backup capability to restore a workload in case of an outage at one of the geographical locations.

One feature of the method and system of the present teaching is that it applies to various subscription-based business assurance platforms so that enterprise IT and cloud service providers can now leverage backup and disaster recovery as a service for cloud solutions in both VMware and OpenStack. The method and system of the present teaching can provide multi-tenant, self-service, policy-based protection of application workloads from data corruption or data loss. The system provides point-in-time snapshots, with configuration and change awareness to recover a workload with one click.

Unlike prior art back up solutions that take a snapshot of the application data running on a single compute node alone, some embodiments of the system and method of the present teaching take a non-disruptive, point-in-time snapshot of the entire workload. That snapshot consists of the compute resources, network configurations, and storage data as a whole. The benefits are a faster and reliable recovery, easier migration of a workload between cloud platforms and simplified virtual cloning of the workload in its entirety.

In some embodiments of the object store backup method of the present teaching, the backup application allows any backup copy, irrespective of its complexity, to be restored with one click. This one-click feature evaluates the target platform and restores the copy once the target platform passes the validation successfully. In some embodiments, a selective restore feature provides enormous flexibility with the restore process, discovering the target platform and providing various possible options to map backup image resources, hypervisor flavors, availability zones, networks, storage volumes, etc.

The system and method of the present teaching supports recovery not only of the entire workload but also individual files. Individual files can be from a point-in-time snapshot via an easy-to-use file browser. This feature provides end-to-end recovery, all the way from workload to individual virtual machine to individual file, providing flexibility to the end user. Based on policy, a tenant can back up a workload (scheduled) and replicate that data to an offsite destination. This provides a copy to restore a workload in case of an outage at one of the geographical locations.

In a virtual computing environment, multiple virtual machines (VMs) execute on the same physical computing node, or host, using a hypervisor that apportions the computing resources on the computing node such that each VM has its own operating system, processor and memory. Under control of a hypervisor, each VM operates as if it were a separate machine, and a user of the VM has the user experience of a dedicated machine, even though the same physical computing node is shared by multiple VMs. Each VM can be defined in terms of a virtual image, which represents the computing resources used by the VM, including the applications, disk, memory and network configuration used by the VM. As with conventional computing hardware, it is important to perform backups to avoid data loss in the event of unexpected failure. However, unlike conventional computing platforms, in a virtual environment the computing environment used by a particular VM may be distributed across multiple physical machines and storage devices.

A virtual machine image, or virtual image, represents a state of a VM at a particular point in time. Backup and retrieval operations need to be able to restore a VM to a particular point in time, including all distributed data and resources, otherwise an inconsistent state could exist in the restored VM. A system and method as disclosed herein manages and performs backups of the VMs of a computing environment by identifying a snapshot of each VM and storing a virtual image of the VM at the point in time defined by the snapshot to enable consistent restoration of the VM. By performing a backup at a VM granularity, a large number of VMs can be included in a backup, and each restored to a consistent state defined by the snapshot on which the virtual image was based.

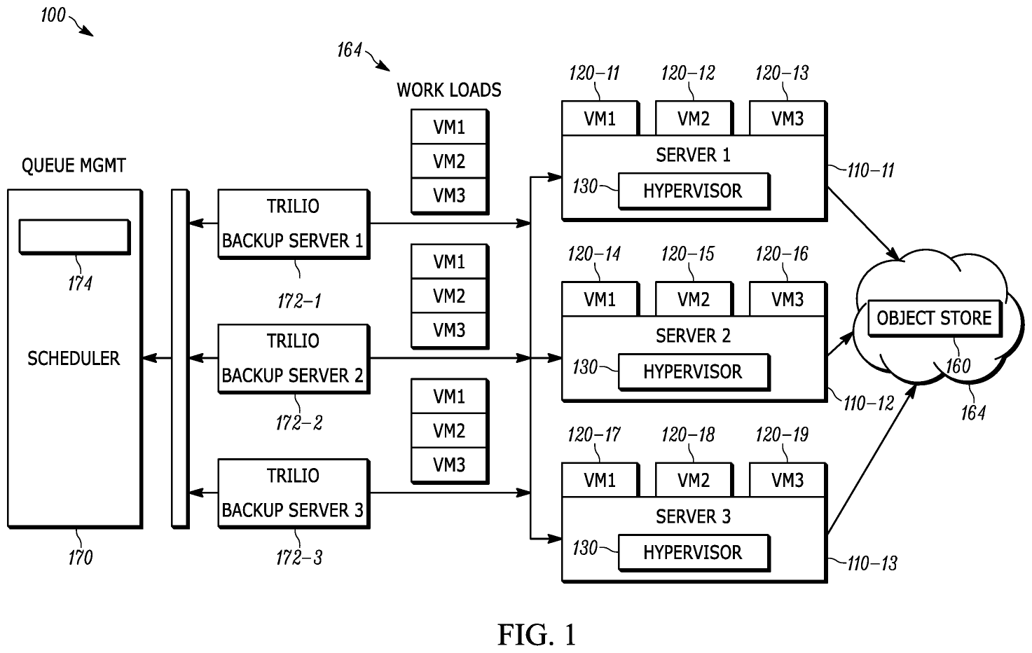

FIG. 1 illustrates an embodiment of a backup operation system and method 100 for a cloud environment according to the present teaching. The backup operation is overseen and managed by a scheduler 170. The scheduler 170 distributes the backup collection effort across a plurality of backup servers (172-1 . . . 172-3 (172 generally). Load balancing logic 174 in the scheduler 170 apportions the collection of the set of data blocks from each of the VMs 120-11 . . . 120-19 as workloads 164 assigned to the backup servers 172. The backup servers 172 traverse the VMs 120 queued in its workload 164 according to backup set calculation logic executing in each backup server 172. In an example configuration, the backup servers 172 may be loaded with software products marketed commercially by TrilioData, of Framingham, Mass., embodying the backup set calculation logic and load balancing logic 174 in the scheduler 170.

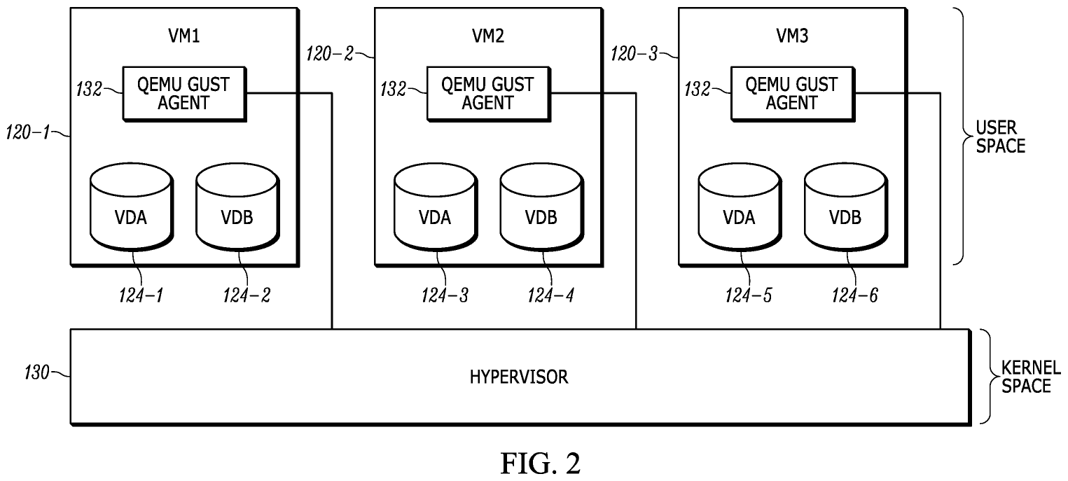

FIG. 2 illustrates an embodiment of a virtual machine VM 120 generally of FIG. 1 in greater detail. Referring to FIGS. 1 and 2, the hypervisor 130 communicates with a guest 132 in each VM 120 including. The guest may take the form of, for example, an agent, process, thread, or other suitable entity responsive to the hypervisor 130 and operable to issue commands to the VM 120. In commencing a backup, the backup servers 172 identify the hypervisor guest 132 in each VM 120, in which the hypervisor guest 132 is responsive to the hypervisor 130 for issuing commands to the VM 120. The backup servers 172 communicate with the hypervisor guest 132 for receiving the traversed blocks for storage. Each VM 120 also has storage in the form of a virtual disk 124-1 . . . 124-6 (124 generally). The virtual disk may take the form of a file system on a partition or a logical volume. In either event, the logical volume represents storage available to the VM for applications executing on it. The logical volume is the “disk” of the virtual machine and is physically stored on a storage array proximate to the computing node, which is distinct from the storage for the backup repository. The backup repository takes the form of an object storage system 160 located in a cloud environment 164.

The mechanism employed to take the backup of VMs 120 running on the hypervisor 130 includes the hypervisor 130, VMs 120, guests 132 and the interaction between hypervisor 130 and the guests 132. In some embodiments, a Linux based KVM as hypervisor is employed, but similar mechanisms exists for other hypervisors, such as VMware® and Hyper-V® that can be employed. Each guest 132 runs as agent called QEMU guest agent, which is software that is beneficial to KVM hypervisors. The guest agents implement commands that may be invoked from the hypervisor 130. The hypervisor 130 communicates with guest agent through a virtio-serial interface that each guest 132 supports. The hypervisor 130 operates in the kernel space of the computing node, and the VMs 120 operate in the user space.

There is a large distribution and granularity of files associated with each VM. One operation that is commonly used with virtual machines is a virtual machine snapshot. A snapshot denotes all files associated with a virtual machine at a common point time, so that a subsequent restoration returns the VM to a consistent state by returning all associated files to the same point in time. Accordingly, when a virtual machine is stored as an image on a hard disk, it is also typical to save all the virtual machine snapshots that are associated with the virtual machine.

Various embodiments of the method and system disclosed herein can also provide a symbiotic usage to backup technologies and virtual image storage for storing VMs. Although though these technologies have evolved independently, they are directed at solving a common problem for providing efficient storage of large data sets and efficient storage of changes that happened to data sets at regular intervals of time.

One open standard that has evolved over the last decade to store virtual machine images is QCOW2 (QEMU Copy On Write 2). QCOW2 is the standard format for storing virtual machine images in Linux with a KVM (Kernel-based Virtual Machine) hypervisor. Configurations disclosed below employ QCOW2 as a means to store backup images. QEMU is a machine emulator and virtualizer that facilitates hypervisor communication with the VMs it supports.

A typical application in a cloud environment includes multiple virtual machines, network connectivity, and additional storage devices mapped to each of these virtual machines. A cloud by definition has nearly unlimited scalable with numerous users and compute resources. When an application invokes a backup, it needs to backup all of the resources that are related to the application: its virtual machines, network connectivity, firewall rules and storage volumes. Traditional methods of running agents in the virtual machines and then backing individual files in each of these VMs will not yield a recoverable point in time copy of the application. Further, these individual files are difficult to manage in the context of a particular point in time. In contrast, configurations described herein provide a method to backup cloud applications by performing backups at the image level. Backing up at the image level involves taking a VM image in its entirety and then each volume attached to each VM in its entirety. Particular configurations of the disclosed approach employ the QCOW2 format to store each of these images.

As described herein, a large number of VM deployments are run using OpenStack components. OpenStack supports a wide variety of cloud infrastructure functionality. OpenStack includes a number of modules, such as, Nova, a virtual machines/compute module, Swift, and object storage module, Cinder, a block storage module, Neutron, a networking module, Keystone, an identity services module, Glance, an image services module and Heat, an orchestration module. Storage functionality is provided by three of these modules. Swift provides object storage, providing similar functionality to Amazon S3. Cinder is a block-storage module delivered via standard protocols such as iSCSI. Glance provides a repository for VM images and can use storage from basic file systems or Swift.

Referring to FIG. 1, the VMs 120 are backed up to a backup target storage system, such as the object storage system 160 in the cloud 164. There are a variety of cloud-based backup storage targets available today, including block storage systems and object storage systems. Object storage, which is supported in OpenStack by Swift, is much more scalable than traditional file system storage because of its simplicity. Object storage systems store files in a flat organization of containers, for example, buckets in Amazon S3. Object storage systems use unique IDs, which are called keys in Amazon S3, to retrieve data from the containers. This is in contrast to the method of organizing files in a directory hierarchy. As a result, object storage systems require less metadata than file systems to store and access files, and object storage reduces the overhead of managing file metadata by storing the metadata with the object.

Object storage can be scaled out to very large sizes simply by adding nodes. Object storage managed by a platform, such as OpenStack is highly available because it is distributed. Packages such as Swift ensure eventual consistency of the distributed storage. It is possible to create, modify, and get objects and metadata by using an object storage API, which is implemented as a set of Representational State Transfer (REST) web services. S3 is a protocol that can front an object store. Ceph is an object storage platform that can have an S3 or a Swift interface, or gateway. S3 and Swift are protocols used to access data stored in the object store.

Block storage is one traditional form of storage that breaks data to be stored into chunks, called blocks, identified by an address. To retrieve file data, an application makes SCSI calls to find the addresses of the blocks and organizes them to form the file. Block storage can only be accessed when attached to an operating system. In contrast, object storage stores data with customizable metadata tags and a unique identifier. Objects are stored in a flat address space, and there is no a limit to the number of objects that can be stored, thus improving scalability. It is widely believed in the industry that object storage will be the best practical option to store the huge volumes expected for unstructured, and/or structured, data storage, because it is not limited by addressing requirements.

Most backup systems and other applications rely upon Network File System (NFS), a distributed file system protocol that supports file access across networked storage resources. When target storage media do not support NFS natively, prior art systems rely on NFS gateway technology to interface between backup applications and storage resources, including block storage and object storage resources. NFS gateways are standalone appliances and introduce another layer of management. In addition, the NFS protocol severely limits both the size and speed of the data storing process. The NFS gateway, therefore, becomes a bottleneck, slowing access speed and reducing scale, for backing up applications.

There has been increasing demand from customers to support object storage as a backup target. Unlike NFS or block storage, object storage does not support random access to objects. Objects need to be accessed in their entirety. That means either the object needs to read as a whole or be modified as a whole. As such, for backup applications to implement a full set of features such as, for example, retention policy, forever incremental, snapshot mount, and/or one click operation of restore, there is a need to layer Portable Operating System Interface (POSIX) file semantics over objects. POSIX is a collection of industry standards that maintain compatibility between operating systems.

Usually backup images tend to be large, so if one object is created for each backup image, then manipulating the backup image requires downloading the entire object and uploading the modified object backup to object store. These operations are inefficient and do not typically perform well. The industry needs a better solution in order to grow as expected. Simple operations, such as a snapshot mount operation, can require accessing the entire chain of overlay files depending on where the latest chunk of data is present. Accessing the latest point in time using the appropriate overlay file is relatively simple with NFS type storage. However, for object store, it requires a download of the entire overlay files in the chain and then mapping the top of overlay file as virtual disk to file manager. In addition, a restore operation also requires similar handling with downloading all the overlay files along the chain and then copying the data to the restored VM or volume.

To overcome these and other challenges, the method and system of the present teaching provides an efficient and effective backup service solution using object storage as the back up target. The method and system of the present teaching supports, for example, Swift- or S3-compatible object store as backup target. The method and system of the present teaching also supports the same, or similar, functionality as NFS backup targets, including, for example the following: snapshot retention policy; snapshot mount; efficient restores with minimum requirement of staging area; and scalability that linearly scales with compute nodes without adding any performance or data bandwidth bottlenecks found in prior art NFS gateway-based solutions.

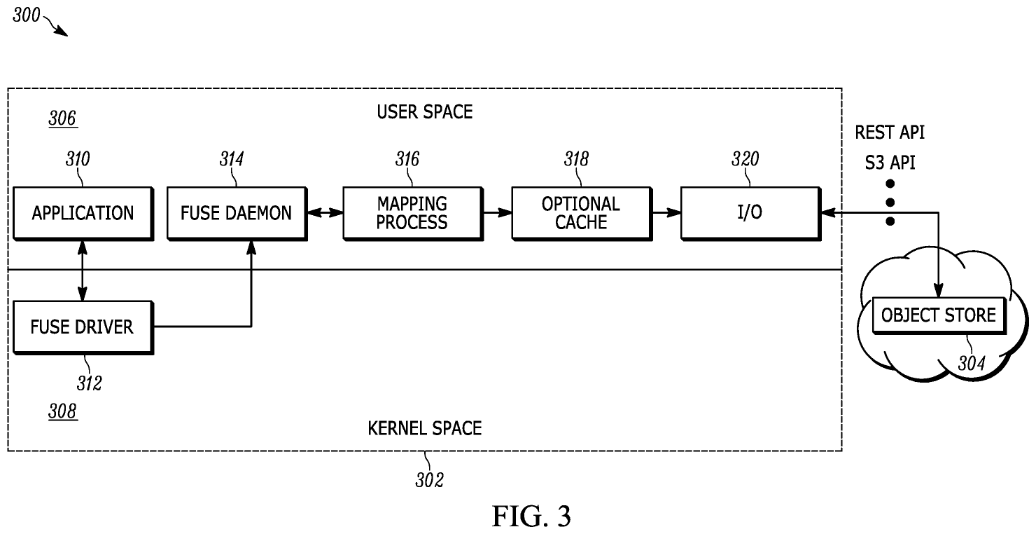

FIG. 3 illustrates an embodiment of an object storage backup system 300 of the present teaching. The object storage backup system 300 backs up data from a compute node 302 to an object storage system 304. The backup system 300 manages each backup image as if it is a file so it can still support all the current functionality that is associated with backup images.

As described earlier, object semantics are not exactly the same as POSIX file semantics. Therefore, in order to map a file to objects, various prior art solutions support NFS gateway to object store. However, the NFS gateway becomes a bottleneck in terms of scale and performance. The object storage backup system 300 uses a different mechanism that maps file to object, but also overcomes the scale performance limits of NFS gateway. Each compute node 302 has a user space 306 and a kernel space 308. The object storage backup system 300 uses data movers on each compute node 302 to scale the backup service. In order to scale to object store, each data store should upload/download file to object store without any NFS gateway in between that supports file semantics to objects in object store. Some embodiments of the present teaching implement file semantics to objects by using Linux FUSE to implement file for objects. FUSE is a software interface for Unix-like computer operating systems that lets users create file system without access to the kernel space 308. Thus, an application 310 in user space 306, connects to a FUSE driver 312 in kernel space 308. The FUSE driver 312 connects to a FUSE daemon 314 in user space.

Since FUSE provides POSIX file semantics for objects, QCOW2 files can be managed using regular qemu-img tools, which means the overlay and sparse functionality can still be preserved. Overlay and sparse functionality are crucial for efficient backups. So, by using FUSE plugin 314, just like file-based QCOW2 files, any overlay file can be accessed and then underlying chain can be accessed as if each object is a local file. The FUSE-based implementation also keeps the changes to traditional backup applications very minimal, as the FUSE mount 312 can be presented as a mount point. The FUSE implementation preserves the file semantics used by the data mover code. The FUSE daemon interfaces to the mapping process 316 of the present teaching. The mapping process 316 maps each object path in an object store to directory of object store 304 to a file using FUSE. Backing reference in QCOW2 file is still a file path and so the mapping process 316 defines the mapping of an object path to a file path.

To implement a backup, random access is required. However objects and object storage usually do not support random access. As such, the objects need to be cached locally in an optional cache module 318. The cache module 318 sits between FUSE plug in 314 and the object repository object store 304. The cache module 318 caches recent writes and reads. Some embodiments of the cache module 318 use a first in first out (FIFO) cache. Other embodiments of cache module 318 implement least recently used (LRU) caching and caches unto five segments of recently used segments. The size of the cache can be tunable based on the desired performance characteristics. The cache allows the backup system 300 to perform the modifications on the object and then upload the object to object store 304 via input output, I/O, 320. Various embodiments of the object store backup method and system use various APIs, such as REST API or S3 API to communicate with and upload and download data to and from the object store 304.

Some embodiments of the present teaching implement a FUSE mount for the entire Swift store. One specific embodiment implements one mount for every tenant. If one single mount is presented for the entire Swift store, it becomes difficult to communicate tenant credentials from FUSE client to the FUSE service. To keep the implementation simple, it is sometimes desirable to implement one mount point per tenant or Swift account.

An example of a FUSE implementation is described further below. FUSE(Passthrough(root), mountpoint, nothreads=True, foreground=True) is Python's way of defining FUSE mount for an object store. For the TriloVault product, the root is the cache area on the local file system where Swift objects are cached, and “mountpoint” is the path on the host, for example, /var/triliovault, that data mover and workload manager uses to access Swift object stores as files.

A Swift object, object1 in container1, in Swift store will have file system path /var/triliovault/AUTH_<tenant_id>/container1/object1. More specifically, for a workload with guid, 4ab68bb5-01e2-4c57-b660-98b2aa3c06b1, to access workload_db, the file path looks like /var/triliovault/AUTH_<tenant_id>/workload_4ab68bb5-01e2-4c57-b660-98b2aa3c06b1/workload_db. For a resource object such as: workload_4ab68bb5-01e2-4c57-b660-98b2aa3c06b1/snapshot_85ed92fc-d52a-48b5-80b9-55e167427f29/vm_id_2b99c2e8-a7b8-4d20-890a-843a40603188/vm_res_id_6f14af84-ed40-4d64-abdc-50b97123bbc0_vda/295b7c9b-lab1-495d-beca-26addd030dde, the file path looks like /var/triliovault/AUTH_<tenant_id>/workload_4ab68bb5-01e2-4c57-b660-98b2aa3c06b1/snapshot_85ed92fc-d52a-48b5-80b9-55e167427f29/vm_id_2b99c2e8-a7b8-4d20-890a-843a40603188/vm_res_id_6f14af84-ed40-4d64-abdc-50b97123bbc0_vda/295b7c9b-1ab1-495d-beca-26addd030dde.

The cache area that the FUSE mount called with will maintain its own internal structure to service Swift objects as files. Let's us assume that /var/vaultcache is the directory that is designated for storing objects and their segments, FUSE mount can be invoked as sudo python /var/vaultcache /var/triliovault.

Larger objects in the Swift store are broken in smaller chunks called segments of fixed size. For example, if the object name of a large object is “my_object” and my object is stored at a location /var/triliovault/AUTH_<tenant_id>/container1/1/2/3/4/5/tvault-recoverymanager-2.0.204.qcow2.tar.gz where 1,2,3,4,5 are sub directories and container1 is name of the container, the cache location will look like /var/vaultcache/AUTH_<tenant_id>/container1/1/2/3/4/5/tvault-recoverymanager-2.0.204.qcow2.tar.gz and each segment is stored as /var/vaultcache/AUTH_<tenant_id>/container1/1/2/3/4/5/tvault-recoverymanager-2._0.204. qcow2.tar.gz_segments/1/2/3/4/5/tvault-recoverymanager-2.0.204.qcow2.tar.gz/1478402081.234585/401820705/33554432/00000000. Each segment usually has the format <objectname include pseudo folders as subdirectories>_segments>/<objectname including pseudo folder structure as sub dirs>/<timestamp>/<objectsize><segmentsize><segmentid>.

A file is defined, called .oscontext in /var/triliovault/AUTH_<tenant_id>, as a means to communicate tenant current credentials to FUSE plugin. FUSE will perform all object operations using the credentials found in this file.

Example FUSE plugin entry points and FUSE file operations are described in more detail below. There are eight FUSE plugin entry points described. The first FUSE plugin is def open(self, path, flags), in which the path is a relative path with respect to fuse mount point, for example, /var/triliovault. Also, for example, the path for workload_db is AUTH_<tenand_id>/workload_<GUID>/workload_db. The first component is parsed for tenant_id and second component can be parsed for container. The rest of the path is the object path including pseudo folders and object name.

The file is opened for the first time. From the FUSE plugin implementation, a disk cache is reserved for the object. The following is the sample code for open:

full_path = self._full_path(path) ← Full path with respect to the vault
cache directory.
/var/vaultcache/<path>
st = self._swift_stat(path) ← make sure the object exists in the object
store
size − int(st[‘headers'][‘content-length’])
head, tail = os.path.split(path)
try:
os.makedirs(self._full_path(head).mode-0o777)← create the directory
structure that reflects object pseudo folder
except OSError.e:
if e.errno != errno.EEXIST:
raise
with open(full_path, “a”) as f:
f.truncate(size) ← truncate the file if the file already exists
manifest = st[‘headers'].get(‘x-object-manifest’,None)
if manifest:
try:
f_path = self._full_path(manifest)
os.makedirs(f_path, mode-0o777)← if the object is large object, we need
to create much deeper sub directories that reflect each object segment.
Except OSError.e:
If e.errno != errno.EEXIST:
raise
fh = os.open(full_path, flags) ← open the file and return the handle
self.manifest[fh] = manifest ← cache manifest of the object
return fh.

The second FUSE plugin is def create(self, path, mode, fi=None)

full_path = self._full_path(path)
return os.open(full_path, os.O_WRONLY | os.O_CREAT, mode).

The third FUSE plugin is def read(self, path, length, offset, fh), in which the path is relative to /var/triliovault. If the offset and length aligns with object segment, if the object is present in the vault cache, and the etag of the cached object matches with etag in the object store, return the object that is present in vault cache. Otherwise, download the object segment(s) that matches the offset and length and return the contents.

segs = get_segment_numbers(offset, length) ← support function that
returns the object segments for offset length
_opts = options.copy( )
_opts[‘object_dd_threads'] = 10
_opts[‘object_threads'] = 10
_opts[‘container_threads'] = 10
_opts[‘skip_identical’] = True
_opts[‘prefix’] = None
_opts[‘out_directory’] = None
_opts[‘yes_all’] = False
_opts = bunchify(_opts) ← construct the options structure for swift
download.
files = [ ]
if self.manifests[fh]:
for s in segs:
files.append(os.path.join(self.manifests[fh], “%08d” % s)) ← get all the
object segments path and create list of object segments to download.
else:
files.append(path) ← if the object is single object without segments, add
the object path here.
# download the object and then serve the data.
for fin files:
container, obj = split_head_tail(f)
full_path = self._full_path(f)
try:
os.stat(full_path) ← find if the object segment already exists in the vault
cache. except:
_opts[‘out_file’] = full_path
args = [container, obj.strip(‘/’)]
vaultswift.st_download(args, _opts) ← if the object segment does not
exists, download the segment.
#print “read, %s, %d, %d” % (path, offset, length)
buf = ″
1 = length
off = offset - segs[0] * OBJECT_SEGMENT_SIZE ← translate the file
read offset to the first object segment of interest.
for f in files:
# translate to file level offset and length and return the data
full_path = self._full_path(f)
if length > OBJECT_SEGMENT_SIZE:
1 = length − OBJECT_SEGMENT_SIZE
else:
1 = length
with open(full_path, “r”) as sf:
buf += sf.read(l)
length −= l
return buf.

The fourth FUSE plugin is def write(self, path, buf, offset, fh), in which the vault cache is written first and then, during close operation, upload the entire object to Swift store. The following code snippet accomplishes that, in a nominally serialized manner:

os.lseek(fh, offset, os.SEEK_SET)
return os.write(fh, buf).

Some embodiments of the method and system according to the present teaching utilize logic that allows writing to cache and uploading the object segment to object store to be parallelized.

The fifth FUSE plugin is def release(self, path, fh), that uploads any modified object segments to Swift store.

#Lets upload the file to object store here:
full_path = self._full_path(path)
container, obj = split_head_tail(path)
# fill up the options structure to pass to swift upload function
_opts = options.copy( )
_opts[‘object_dd_threads'] = 10
_opts[‘object_threads'] = 10
_opts[‘container_threads'] = 10
_opts[‘skip_identical’] = True
_opts[‘segment_size’] = ‘33554432’
_opts[‘segment_container’] = path.strip(‘/’) + “_segments”
_opts[‘prefix’] = None
_opts[‘yes_all’] = False
_opts[‘object_name’] = obj.rstrip(‘/’) ← name of the object including
subdirectories. This is path relative to mount point.
_opts = bunchify(_opts)
args = [container, full_path.rstrip(‘/’)] ← path relative to vault cache
vaultswift.st_upload(args, _opts)
os.close(fh)
os.remove(full_path) ← clear the object
return
1. stat( ):
2. unlink( ):
3. create( ).

The sixth FUSE plugin is def truncate(self, path, length, fh=None). This will truncate the cached object. This call may or may not be seen with data mover.

full_path = self._full_path(path)
with open(full_path, ‘r+’) as f:
f.truncate(length).

The seventh FUSE plugin is def flush(self, path, fh):
return os.fsync(fh).

The eighth FUSE plugin is def fsync(self, path, fdatasync, fh):
return self.flush(path, fh).

Fifteen exemplary FUSE file system operation examples are described below. The first FUSE file system operation is def access(self, path, mode), in which there is nothing to do, so just return.

The second FUSE file system operation is def chmod(self, path, mode):
full_path=self._fullpath(path)
return os.chmod(full_path, mode)←This only changes the mode for cached copy. The procedure may fail if the object is not cached. Some embodiments handle the case when an object is not cached.

The third FUSE file system operation is def chown(self, path, uid, gid):
full_path=self._full_path(path)
return os.chown(full_path, uid, did)←This only changes the ownership for cached copy. The procedure may fail if the object is not cached. Some embodiments handle the case when object is not cached.

The fourth FUSE file system operation is def getattr(self, path, fh=None). This is a relatively complex entry point at the file system level operations. This function returns attributes for directories and files. If the object is already cached, it uses os.stat( ). Otherwise, it performs a Swift stat call and returns the object information:

full_path = self._full_path(path)
container, prefix = split_head_tail(path)
_opts = options.copy( )
if container == ″:
args = [ ]
else:
args = [container]
_opts[‘delimiter’] = None
_opts[‘human’] = False
_opts[‘totals'] = False
_opts[‘long’] = False
_opts[‘prefix’] = None
#st_mode=33261, st_ino=2366145, st_dev=2049L, st_nlink=1,
st_uid=1000,
#st_gid=1000, st_size=50801, st_atime=1476567525,
st_mtime=1476567517,
#st_ctime=1476567517 # file
#st_mode= 16893, st_ino=2364009, st_dev=2049L,
st nlink=3, st_uid=1000,
#st_gid=1000, st_size=4096, st_atime=1476591610,
st_mtime=1476591590,
# st_ctime=1476591590 # directory
_opts = bunchify(_opts)
d = { }
if prefix != ″:
args = [container, prefix.strip(‘/’)]
d[‘st_gid’] = 1000
d[‘st_uid’] = 1000
try:
st = vaultswift.st_stat(args, _opts)
d[‘st_atime’] = int(st[‘headers'][‘x-timestamp’].split(‘.’)[1])
d[‘st_ctime’] = int(st[‘headers'][‘x-timestamp’].split(‘.’)[0])
d[‘st_mtime’] = int(st[‘headers'][‘x-timestamp’].split(‘.’)[0])
d[‘st_nlink’] = 1
d[‘stmode’] = 33261
d[‘st_size’] = int(st[‘headers'][‘content-length’])
if d[‘st_size’] == 0: ← this is a directory
d[‘st_nlink’] = 3 ← This is the number of files with in the directory. 3 is
not the right value. So it is changed to actual number of objects:
d[‘st_size’] = 4096
d[‘st_mode’] = 16893
except:
full_path = self._full_path(path) ← The object may not yet be uploaded
and may still be in the cache. This happens when a file is created and
streaming has started.
st = os.lstat(full_path)
d = dict((key, getattr(st, key)) for key in (‘st_atime’, ‘st_ctime’,
‘st_gid’, ‘st_mode’, ‘st_mtime’, ‘st_nlink’, ‘st_size’, ‘st_uid’))
else: ← someone did an “ls” command on the container.
prefix = None
_opts[‘prefix’] = prefix
args = [container]
try:
objs = vaultswift.st_list(args, _opts)
# psuedo folder
args = [container]
st = vaultswift.st_stat(args, _opts)
d[‘st_atime’] = int(st[‘headers'][‘x-timestamp’].split(‘.’)[0])
d[‘st_ctime’] = int(st[‘headers'][‘x-timestamp’].split(‘.’)[0])
d[‘st_mtime’] = int(st[‘headers'][‘x-timestamp’].split(‘.’)[0])
d[‘st_nlink’] = 3
d[‘st_size’] = 4096
d[‘st_mode’] = 16893
except:
full_path = self._full_path(path) ← A new workload is created, but has
not been uploaded to object store, so local stat is used.
st = os.lstat(full_path)
d = dict((key, getattr(st, key)) for key in (‘st_atime’, ‘st_ctime’,
‘st_gid’, ‘st_mode’, ‘st_mtime’, ‘st_nlink’, ‘st_size’, ‘st_uid’))
return d.

The fifth FUSE file system operation is def readdir(self, path, fh). This operation provides directory listing of objects within container or pseudo folders.

listing = [ ]
container, prefix = split_head_tail(path)
_opts = options.copy( )
_opts[‘delimiter’] = None
_opts[‘human’] = False
_opts[‘totals'] = False
_opts[‘long’] = False
args = [ ]
if container == ″:
args = [ ]
else:
args = [container]
if prefix == ″:
prefix = None
_opts[‘prefix’] = prefix
_opts = bunchify(_opts)
listing += vaultswift.st_list(args, _opts) ← get the object lists under
either container or pseudo folder.
dirents = set([‘.’, ‘..’])
for 1 in listing:
if prefix:
component, rest = split_head_tail(l.split(prefix)[1])
else:
component, rest = split_head_tail(l)
if component is not None or component != ″ or not
component.endswith(‘_segments'):
dirents.add(component)
for r in list(dirents):
yield r.

The sixth FUSE file system operation is def readlink(self, path):

pathname = os.readlink(self._full_path(path))
if pathname.startswith(“/”):
# Path name is absolute, sanitize it.
return os.path.relpath(pathname, self.root)
else:
return pathname.

The seventh FUSE file system operation is def mknod(self, path, mode, dev):
return os.mknod(self._full_path(path), mode, dev).

The eight FUSE file system operation is def rmdir(self, path):

full_path = self._full_path(path)
return os.rmdir(full_path).

The ninth FUSE file system operation is def mkdir(self, path, mode):
return os.mkdir(self._full_path(path), mode).

The tenth FUSE file system operation is def statfs(self, path):

_opts = options.copy( )
_opts = bunchify(_opts)
container, obj = split_head_tail(path)
stv = vaultswift.st_stat([container, obj], _opts)
#convert these to these attributes
return dict((key, getattr(stv, key)) for key in (‘f_bavail’, ‘f_bfree’,
‘f_blocks', ‘f_bsize’, ‘f_favail’, ‘f_ffree’, ‘f_files', ‘f_flag’,
‘f_frsize’, ‘f_namemax’)).

The eleventh FUSE file system operation is def unlink(self, path):

container, obj = split_head_tail(path)
_opts = options.copy( )
_opts[‘object_threads'] = 10
_opts[‘yes_all’] = False
_opts = bunchify(_opts)
try:
vaultswift.st_delete([container, obj.strip(‘/’)], _opts) ← clear the object
in object store
except:
raise
try:
vaultswift.st_delete([container, obj.strip(‘/’) + “_segments”], _opts) ←
clear the _segments object for large objects
except:
pass
try:
return os.unlink(self._full_path(path)) ← clear the cached object from
vault cache.
except:
pass.

The twelfth FUSE file system operation is def symlink(self, name, target):
return os.symlink(name, self._full_path(target)).

The thirteenth FUSE file system operation is def rename(self, old, new):
return os.rename(self._full_path(old), self._full_path(new)).

The fourteenth FUSE file system operation is def link(self, target, name): return os.link(self._full_path(target), self._full_path(name)).
The fifteenth FUSE file system operation is def utimens(self, path, times=None):
return os.utime(self._full_path(path), times).

Some embodiments of the method and system of the present teaching have FUSE file operations performance that is comparable to Swift object operations. Example performance metrics include the overhead percentage. In some embodiments the overhead for FUSE file operations is between five and ten percent.

Some embodiments maintain a pseudo-folder-to-POSIX-directory mapping. From the vault.py point of view, all resources are created in their own directories and each directory. Since object store does not support directories or folders, it is necessary to map each directory entry in vault to the pseudo folder in the object store. One feature of a FUSE plugin is that each FUSE entry point receives full path with respect to the mount point. So it is possible to reference the entire object from FUSE plugin to Swift object. Some embodiments of the method support one fuse mount for the entire object store. One advantage of these embodiments is that this is only process being used. Also, the method scales well with the number of tenants. The disadvantage is that a method is needed to pass per tenant credentials to the FUSE plugin. Some embodiments of the method support one fuse mount per tenant. The advantage is that it is easy to pass tenant credentials to the FUSE plugin. The disadvantage is that many processes are spawned to service multiple tenants and so scaling is an issue.

Objects can be of arbitrary size. If the object is too large, it is not possible to download the object and upload the object for every small modification. Thus, backup images are segmented into manageable chunks, or segments, and the segments are uploaded to object store. Swift supports two ways to break up large objects, including dynamic large objects and static large objects. Some embodiments of the present teaching use dynamic large objects in which each object can be of size 5 MB. This object size is a little more than a typical file block and, therefore, this object size is just enough size for managing each object efficiently. Currently, QCOW2 images have default cluster size 64K. As such, some embodiments change the size to 5 MB to match to object size.

One feature of the present teaching is that it supports multi-tenancy. The backup system 300 uses Swift/S3 tenant credentials that may be preserved through FUSE mount. In some embodiments, the backup system 300 is a multitenant backup application 310. Also, in some embodiments, the object store 304 is tenant aware. In these embodiments, unlike NFS file systems, each object owner is created by the tenant and the private objects can be accessed only by the tenant.

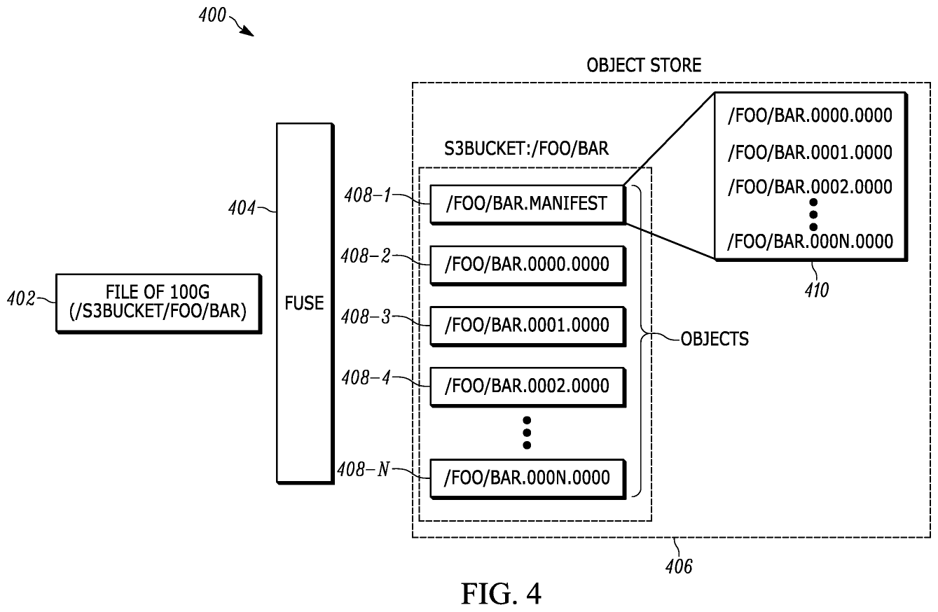

FIG. 4 illustrates a schematic 400 showing how the Linux file personality is mapped to objects in the object store using an embodiment of the system and method of the present teaching. A file 402 is located at path /s3bucket/foo/bar. For example, this file may contain file data for an application being backed up. The file can comprise a snapshot of application data, or the file can comprise a snapshot of an entire workload. Also, the file can comprise a point-in-time representation of a particular process or processes running on one or more virtual machines. In this example, the file is 100 G in size. The path, /s3bucket, is a local folder where an s3bucket is FUSE mounted 404 and file data and metadata are uploaded to the object store 406 directly, with no NFS gateway or similar function in between. File data in the file 402 is divided into various segments. Each segment is uploaded as an object 408. The object store 406 stores a manifest object 408-1 that contains metadata used in mapping file data to the file segments that become objects in the object store. Manifest object 408-1 contains the manifest metadata illustrated in the detail 410 of manifest object 408-1. The object store 406 stores uploaded segments comprising file data from the file 402 as N−1 objects 408-2 . . . 408-N. The number, N, depends on the size of the file 402 and on the size of file segments. In some embodiments, each segment comprises approximately 5 MB of data or less.

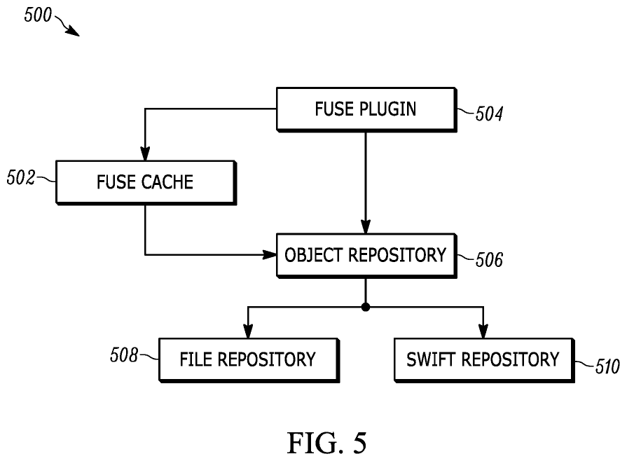

FIG. 5 illustrates a class diagram 500 of an embodiment of the object store backup method and system of the present teaching. A cache module 502 sits between the FUSE plug in 504 and the object repository 506. In some embodiments, the cache module 502 caches recent writes and reads. Some embodiments implement LRU cache and caches unto 5 segments of recently used segments. The size and type of the cache can be tunable based on desired performance characteristics. The object repository 506 is the base class that represents the backend for FUSE plugin 504. The FUSE cache module 502 interacts with the object repository module 506 to read and write actual segments when the cache module 502 misses a segment. File repository 508 implements the file backend. Some embodiments do not use a FUSE plugin 504 for file backend. However, embodiments that use the FUSE plugin 504 have a convenient way to test FUSE functionality and its various operating parameters.

Some example operations are described below. To implement, for example, object_open( ) first a new cache is created to hold the object segments, using:

fh = self.repository.object_open(object_name, flags)
self.lrucache[fh] = {‘lrucache’: LRUCache(maxsize=CACHE_SIZE),
‘object_name’: object_name}

To implement object_close( ) the following can be used:

self,object_flush(object_name, fh)
self.repository.object_close(object_name, fh)
self.lrucache.pop(fh)

To implement object_flush( ), first clear the cache. If the cache is holding any modified segments, upload them to object store, as follows:

while True:
off, item = cache.popitem( )
if item[‘modifιed’] == True:
self.repository.object_upload(object_name, off, item[‘data’])

To implement object_read( ) a for loop iterates through all segments that the current request overlaps. A walk_segments( ) iterates through all the segments. The body of the for loop tries to get the segment data from the cache. If the data is found in the cache, it is returned immediately. If the cache is missed, the object is downloaded from the object storage, the cache is updated, and data is returned to the client in the following way.

for segoffset, base, seg_len in self._walk_segments(offset, length):
try:
segdata = self.lrucache[fh][‘lrucache’][segoffset][‘data’]
except:
try:
# cache miss. load the data from the segment
segdata = self.repository.object_download(object_name, segoffset)
except:
# end of file
return 0
self.lrucache[fh][‘lrucache’][segoffset] = {‘modified’: False, ‘data’:
segdata }
output_buf += segdata[base:base+seg_len]

To implement object_write( ) the following steps are performed. For each segment that the write request falls into, if the segment data is not in the cache, then the segment data is loaded from object store. If the cache is already full and the cache segment needs to be evicted, then choose the segment that needs eviction. If the segment is modified, then upload the segment to object store and then fill the slot with new segment data. Write to the segment data in the cache.

The Swift repository 510 class implements Swift as backend. Each file that is created via the FUSE plugin 504 is an object on Swift data store. Some embodiments of the Swift repository 506 use SLO (static large objects) with each segment size standardized to 32 MB. To keep the object layout standard, all files including files that are less than 32 MB are created as SLO. If the file name is x/y/z, then Swift object is created in container x and the object name is y/z. The object y/z is a manifest object and the actual segments that belong to this object are under y/z_segments pseudo directory. The name of each segment has two components separated by ‘.’. The first component is the hex representation of offset of the segment within the file. For example, the first segment is represented as 0000000000000000.xxxxxxxx and the second segment is named as 0000000002000000.xxxxxxxx. The second component of the segment represents the number of times this segment is written. The second component may be referred to as an ‘epoch’. The significance of the second component is described further below.

Backup images are immutable images. However, since backup applications of the present teaching support both incremental forever and full backup synthesis, it is necessary to modify full backup images to consolidate full backup with immediate incremental which means writing incremental back ups to full backups. The object implementation typically preserves file semantics and also makes the file modifications atomic. This means that if, for example, a QEMU commit operation fails in between, the full image is kept intact.

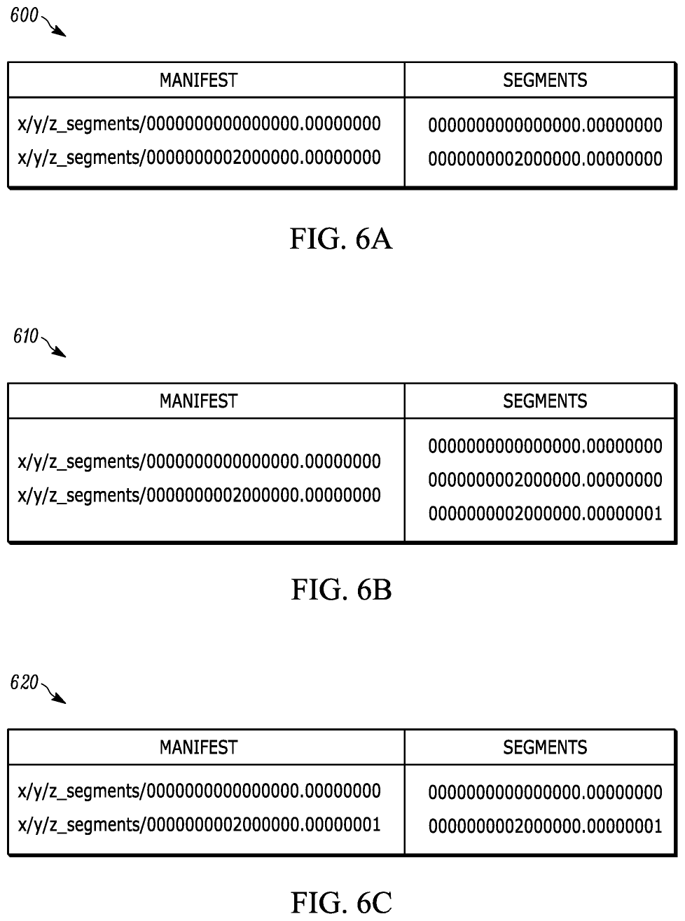

To preserve file level semantics an epoch component is used in the segment name. FIGS. 6A-C illustrate a succession of objects during a portion of an embodiment of a backup operation to illustrate the use of the epoch component of the present teaching. FIG. 6A illustrates an embodiment of an object 600 of the present teaching that comprises two segments when the object 600 being created first. FIG. 6B illustrates an embodiment of an object 610 of the present teaching that comprises two segments when the file is opened for a read/write operation and then written to. FIG. 6C illustrates an embodiment of an object 620 of the present teaching that comprises two segments when the file is orderly closed. These stages of object 600, 610, 620 help to illustrate how the epoch component works.

Referring to FIGS. 6A-C, when object 600 is created for the first time, an epoch of 0 is assigned. When the file is opened for read/write and written to the second segment, then the object storage for the object appears as object 610. As such, if the process crashes at this point, the manifest still points to old segment and there is no data corruption. Upon an orderly close, the object appears as object 620.

One feature of the present teaching is that it maintains continuity when a file is moved or renamed. When a file is renamed or moved, the data remains consistent but the logical location changes. Embodiments of the backup method and system of the present teaching address this by changing the location of the manifest file to the new location (directory) but keeping the existing segments in the same location by creating a new manifest file with the old location information.

As an example of a rename scenario, when an object with a key of topDir/nextDir/FileName1.bin is renamed, or moved, to topDir/anotherDir/NewFileName.bin, the manifest file objects are FileName1.bin.manifest and NewFileName.bin.manifest. In this example, the following operations are performed: (1) new manifest is created at the new location with the contents of the old manifest; (2) topDir/anotherDir/NewFileName.bin.manifest is created but the segment-directory (object path) and segment information points to topDir/nextDir/FileName1.bin-segment; (3) once the new manifest (NewFileName.bin.manifest) has been uploaded at the new location (topDir/anotherDir/NewFileName.bin.manifest) the old manifest is removed; (4) these operations result in a new manifest pointing to the old data. As a result of these operations, no data is moved in the object store, just a reference to the location of the segments that make up the object. Only the I/O transactions required to create the new manifest and remove the old one are performed. The contents of the original object segments are not moved.

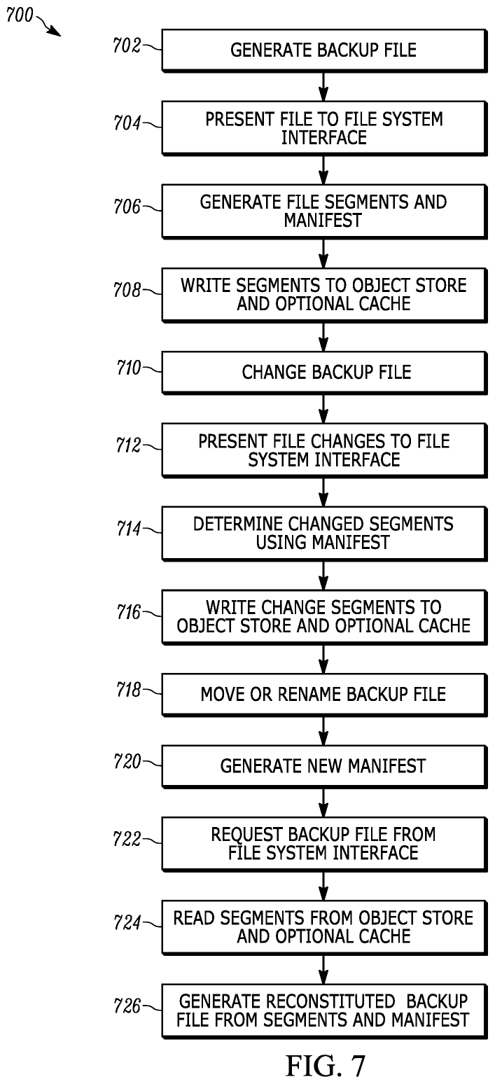

FIG. 7 illustrates a flow chart 700 of an embodiment of a method and system to backup an application to an object storage system according to the present teaching. The backup application generates a file to be backed up in step one 702 of the method. In various embodiments, this file to be backed up can represent information relating to a number of different aspects of backing up application running on virtual machines, or a variety of cloud based operations. For example, in some embodiments the file is a snapshot of a virtual machine. For example, in some embodiments the file is a file generated by an application running in the cloud that is being backed up. In step two 704, the file is presented to a file system interface. In some embodiments, the file system interface is a locally-mounted file system representation. In other words, the interface is a software process that presents a representation of a locally-mounted file system to an application. For example, this may be a system or process that presents an interface compatible with a POSIX file representation. In some embodiments, this interface is a FUSE file system interface.

In step three 706, a mapping process begins. A manifest is generated based on the file, and the file is broken into file segments. The manifest represents metadata about the file segmentation. The metadata informs a mapping of segments to the file presented the locally-mounted file system. In step four 708 of the method, the file segments are uploaded to an object storage system. Each file segment corresponds to an object in the object store. The manifest is also uploaded as an object in the object store. In some embodiments, a cache is used between the locally-mounted file system process and the object store to cache recent reads and writes from the application to the locally-mounted file system process.

To continue with a backup after a change is made to the system or application being backup, the method proceeds to a step five 710 in which a change is made to the backup file. For example, this change may represent a particular point in time of a virtual-machine-based process. This change may represent a change to data in a file that is used by the application. The file system changes are presented to the locally-mounted file system process in step six 712 of the method. Based on the changes, the mapping process determines which file segments are changed in step seven 714. The changed segments are uploaded to corresponding objects in the object store in step eight 716. One benefit of the system and method of the present teaching is that only file segments representing changed data needs to be uploaded to the object store. This feature is similarly applied to downloads from the object store of requested or retrieved data, as will be understood by those skilled in the art.

In some embodiments, the file being backup may be moved or renamed. In these embodiments the method process proceeds to a step nine 718, in which the backup file is moved or renamed. A new manifest is generated in step ten 720. The location of the manifest file is changed to the new location or directory, but the existing segments are kept in the same location by creating the new manifest with the old location information. This results in a new manifest pointing to the old data, and no data is moved in the object store.

In some embodiments, the backup application may request the backup file from the locally-mounted file system interface. The method proceeds to a step eleven 722, and a process to recover the backup file initiates reads from the locally-mounted file system interface. The necessary data is retrieved in step twelve 724. In some embodiments of the method, the objects corresponding to the read-requested file segments are downloaded from the object store. In some embodiments of the method, a full download from the object store is not needed because the changes all reside in the local cache. As discussed herein, one feature of the system and method of the present teaching is that only particular objects need to be downloaded from the object store to meet the request. Thus, the entire set of objects containing file data do not need to be downloaded.

The backup application then generates a reconstituted backup file from the file segments that are presented via the locally-mounted file system interface in step thirteen 726.

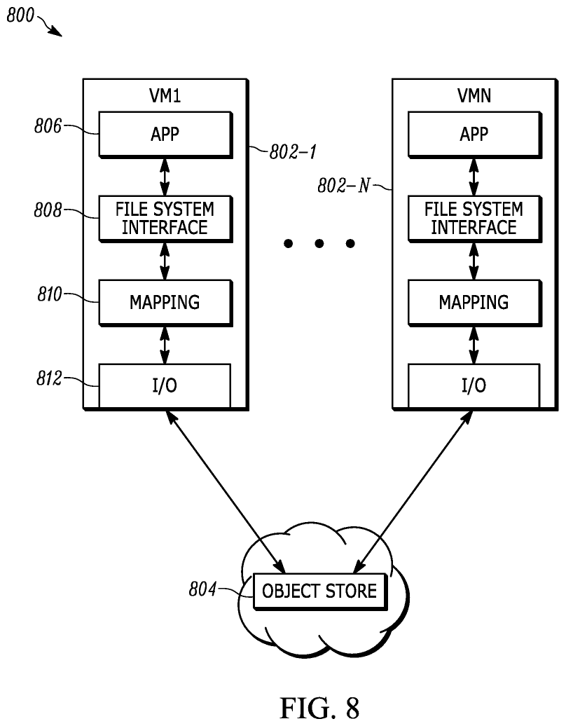

One feature of the object store backup system and method of the present teaching is that it scales well to large and/or widely distributed cloud-based systems and processes. FIG. 8 illustrates an embodiment of the object store backup system 800 of the present teaching in the case where multiple nodes are backed up to a common object store. A number of nodes, each running a virtual machine 802-1 . . . 802-N, are connected to an object store 804. Each node comprises a process that runs the backup application 806, the file system interface process 808, the mapping process 810, and the input/output 812. In each node, as described above, the file data from broken into file segments, and a manifest comprising metadata is generated. The file segments and manifest are uploaded as corresponding objects in the object store 804 from each node.

In this way, the system is able to scale to very large sizes, with a large number of virtual machines and/or very large application file sizes. One skilled in the art will appreciate that the object store 804 system may be localized or distributed.

One feature of the present teaching is the ability to provide POSIX file semantics to files stored in an object store as object store buckets by using a FUSE process layer. The system implements a stat( ) method which includes mapping file attributes to object manifest metadata attributes. One skilled in the art will appreciate that a stat( ) function obtains status of a file. Stat( ) thus obtains information about a named file that is pointed to by a path. Thus, by using a FUSE process, the resulting object store buckets are presented as a locally mounted file system. This allows existing and new backup applications, such as TrilioVault, to seamlessly use object storage as a backup target.

One skilled in the art will also appreciate that object stores do not have a concept of file directories that are required by prior art backup applications. Thus, in the systems and methods of the present teaching, the file directory becomes the prefix to an object, basically the address or full name. Thus, in some embodiments of the method according to the present teaching, in order to represent directories and sub directories in S3, an object is created for each directory and the ContentType is set to “application/x-directory”, if this is supported by the particular S3 implementation. Otherwise, the “ContentLength” is set to 0 in the object header. The object in object store can be considered a directory because directories do not contain any segments.

In some embodiments, the objects stored in the object store contain some metadata that is used to identify the object role or characteristics of the file. The amount and type of metadata depends on the role of the object. When a file system looks at a file and presents that information to the user, it returns an expected set of values. For example, these values can be the file name, file size, blocks, block size, access time, modified time, changed time, user id, group id, or file access. This information is mapped and returned to a FUSE layer by using the following construct: File Name, the name of the directory object or file marker/manifest; File Size; Blocks; Block Size; Access Time, set to the object's Last Modified time; Modified Time, set to the object's Last Modified time; Changed Time, set to the object's Last Modified time.

For example:

File: ‘test.pdf’
Size: 823807 Blocks: 1616 IO Block: 4096 regular file
Device: fc00h/64512d Inode: 9179774 Links: 1
Access: (0664/-rw-rw-r--) Uid: ( 1000/ ckacher) Gid: ( 1000/ ckacher)
Access: 2018-02-13 17:03:03.124659172 -0500
Modify: 2016-07-08 16:49:35.000000000 -0400
Change: 2017-11-02 15:32:10.196737834 -0400
Birth: -

File system files only exist in the form of a “file marker” object, which is also referred to as a manifest. This file marker represents the name of the file followed by “.manifest” and contains no actual file information. However, it does contain information about the file and how it is segmented. When a user lists a directory in order to access information, only directories and files with the “.manifest” extension are returned. The “.manifest” extension is stripped prior to returning the name of the “file marker.”

For example, in order to represent a file named “test.txt”, an object will be stored with the name “file.txt.manifest” in the object store. File marker objects contain additional metadata that is not stored in the object, but associated with it: segments-dir, the location of the object segments that make up the file represented by the file manifest object; segment-count, the number of segments used to represent the file; total-size, the aggregate size of the file if all of the segments were assembled into a single file.

Data stored as metadata can be obtained without needing to retrieve the whole object and assembling it in order to display an accurate file size to the user. The segment-count and total-size are updated as each segment is uploaded and the metadata for the manifest file is periodically updated in order to reflect the fact that the upload is in progress.

Although many of the embodiments above are described with respect to FUSE- and Swift-based implementations, one skilled in the art will appreciate that the method and system of the present teaching apply to a variety of known file system representation interfaces and systems and object store interfaces and systems. For example, S3 and/or [ . . . ] may be used as an object store interface.

### EQUIVALENTS

While the Applicant's teaching is described in conjunction with various embodiments, it is not intended that the Applicant's teaching be limited to such embodiments. On the contrary, the Applicant's teaching encompass various alternatives, modifications, and equivalents, as will be appreciated by those of skill in the art, which may be made therein without departing from the spirit and scope of the teaching.

What is claimed is:

1. A computer-implemented method of backing up an application to an object storage system, the method comprising:
a) receiving a file comprising data from the application being backed up to the object storage system at a locally-mounted-file-system representation;
b) generating a manifest comprising file segment metadata based on the file;
c) generating at least one file segment comprising at least some of the data;
d) storing the at least one file segment comprising at least some of the data as at least one corresponding object comprising the at least some of the data in the object storage system; and
e) storing the manifest as an object in the object storage system.

2. The computer-implemented method of backing up the application to the object storage system of claim 1 further comprising retrieving data from the application being backed up to the object storage system.

3. The computer-implemented method of backing up the application to the object storage system of claim 2 further comprising determining at least one corresponding object comprising at least some of the retrieved data in the object storage system based on the file segment metadata in the manifest.

4. The computer-implemented method of backing up the application to the object storage system of claim 3 further comprising retrieving the determined at least one corresponding container comprising at least some of the retrieved data from the object storage system.

5. The computer-implemented method of backing up the application to the object storage system of claim 4 further comprising presenting the at least some of the retrieved data to the application using the locally-mounted-file-system representation.

6. The computer-implemented method of backing up the application to the object storage system of claim 1 further comprising moving the file and generating a new manifest wherein the new manifest points to the at least one corresponding object comprising at least some of the data in the object storage system.

7. The computer-implemented method of backing up the application using the object storage system of claim 1 further comprising storing at least one file segment in a last-in-first-out cache.

8. The computer-implemented method of backing up the application using the object storage system of claim 1 further comprising generating access credentials associated with the file comprising data from the application being backed up to the object storage system and communicating the access credentials to the object store.

9. The computer-implemented method of backing up the application using the object storage system of claim 8 wherein the access credentials comprise tenant access credentials.

10. The computer-implemented method of backing up the application using the object storage system of claim 1 wherein the locally-mounted-file-system representation comprises a FUSE daemon.

11. The computer-implemented method of backing up the application using the object storage system of claim 1 wherein the locally-mounted-file-system representation comprises POSIX file semantics.

12. The computer-implemented method of backing up the application using the object storage system of claim 1 wherein the file segment metadata comprises file segment size information.

13. The computer-implemented method of backing up the application using the object storage system of claim 1 wherein the file segment metadata comprises file segment offset information.

14. The computer-implemented method of backing up the application using the object storage system of claim 1 wherein a size of at least one file segment is less than or equal to 32 Megabytes.

15. The computer-implemented method of backing up the application using the object storage system of claim 1 wherein a size of the file is greater than or equal to 100 Gb.

16. The computer-implemented method of backing up the application using the object storage system of claim 1 wherein the file comprises a snapshot of a virtual machine.

17. The computer-implemented method of backing up the application using the object storage system of claim 1 wherein the file comprises a QCOW2 image.

18. The computer-implemented method of backing up the application using the object storage system of claim 1 wherein the object storage system comprises an S3 interface.

19. The computer-implemented method of backing up the application using the object storage system of claim 1 wherein the object storage system comprises a Swift interface.

20. The computer-implemented method of backing up the application using the object storage system of claim 1 wherein the object storage system comprises a Ceph object storage system.

21. The computer-implemented method of backing up the application using the object storage system of claim 1 wherein the object storage system resides in a cloud environment.

22. The computer-implemented method of backing up the application to the object storage system of claim 1 wherein the receiving the file comprising data from the application being backed up to the object storage system comprises receiving the file based on receiving a write command.

23. The computer-implemented method of backing up the application using the object storage system of claim 1 further comprising storing at least one file segment in a least recently used cache.

24. The computer-implemented method of backing up the application using the object storage system of claim 1 wherein a name of at least one file segment comprises a first and second component.

25. The computer-implemented method of backing up the application using the object storage system of claim 24 wherein at least one of the first and second components represents an offset.

26. The computer-implemented method of backing up the application using the object storage system of claim 24 wherein at least one of the first and second component represents a number of times the at least one file segment is written.

27. The computer-implemented method of backing up the application using the object storage system of claim 1 wherein the object storage system comprises a flat organization of objects.

28. The computer-implemented method of backing up the application using the object storage system of claim 1 wherein the locally-mounted file system representation comprises a file directory.

29. A computer backup system comprising:
a) a computer node configured to backup an application using a locally-mounted-file-system representation;
b) a processor electrically connected to the computer node and configured to:
i. receive a file comprising data from the application being backed up;
ii. generate a manifest comprising file segment metadata based on the file; and
iii. generate at least one file segment comprising at least some of the data; and
c) an object store system electrically connected to the processor, the object store system storing the generated at least one file segment comprising at least some of the data as at least one corresponding object comprising at least some of the data in the object storage system and storing the generated manifest as an object in the object storage system.

30. The computer backup system of claim 29 further comprising a scheduler that is electrically connected to the processor.

31. The computer backup system of claim 29 further comprising a computer memory electrically connected to the processor and configured to store the file segment sizes and file segment offsets of each of the plurality of file segments that represents the back-up file in a manifest.

32. The computer backup system of claim 29 wherein the processor comprises a virtual machine.

33. The computer backup system of claim 29 wherein the processor comprises a CPU.

34. The computer backup system of claim 29 wherein the processor comprises a computer server.

35. The computer backup system of claim 29 wherein the object store system resides in a cloud computing environment.

36. The computer backup system of claim 29 wherein the object store system resides in a data center.
